(19) United States
(12) Patent Application Publication
(10) Pub. No.: US 2023/0006220 A1
(43) Pub. Date: Jan. 5, 2023

(54) Fuel Cell Component and Method for Thermal Management of a Fuel Cell Component

(71) Applicant: Robert Bosch GmbH, Stuttgart (DE)

(72) Inventors: Xu Zhang, Shanghai (CN); Guoqing Hu, Shanghai (CN); Xu Xie, Shanghai (CN); Bicheng Chen, Shanghai (CN)

(21) Appl. No.: 17/842,223

(22) Filed: Jun. 16, 2022

(30) Foreign Application Priority Data
Jul. 1, 2021 (CN) 202110744025.2

(51) Int. Cl. H01M 8/0267; H01M 8/04029; H01M 8/0263; H01M 8/04701

(52) U.S. Cl. CPC H01M 8/0267; H01M 8/04029; H01M 8/0263; H01M 8/04701

(57) ABSTRACT

The present disclosure relates to the field of fuel cells. The present disclosure relates to a fuel cell component, comprising a plate body, with the following provided on the plate body: an anode gas flow path leading from an anode inlet to an anode outlet; a cathode gas flow path leading from a cathode inlet to a cathode outlet; and a coolant flow path leading from a coolant inlet to a coolant outlet, the coolant flow path being configured such that coolant is partially diverted from the coolant inlet to a designated region of the plate body and mixes with an undiverted portion in the designated region, in order to enhance cooling capacity in the designated region by means of the mixed coolant. The present disclosure also relates to a fuel cell system and a heat management method for the fuel cell component.

This application claims priority under 35 U.S.C. § 119 to application no. CN 02110744025.2, filed on Jul. 1, 2021 in China, the disclosure of which is incorporated herein by reference in its entirety.

### TECHNICAL FIELD

The present disclosure relates to a fuel cell component, a fuel cell system, and a heat management method for a fuel cell component.

### BACKGROUND

Fuel cells are widely used in the field of electric vehicles as a clean energy source capable of reducing greenhouse gas emissions. However, the output performance of a fuel cell is affected by many factors, amongst which, an excessively high temperature will lead directly to a drop in the stability and proton conduction ability of the proton exchange membrane, thereby affecting the lifespan of the fuel cell as a whole. Thus, rational arrangement of a cooling flow field of the fuel cell is of major significance.

Most conventional bipolar plates remove heat from the stack via regularly arranged coolant flow paths, but due to the compact design of bipolar plates of proton exchange membrane fuel cells, it is generally necessary to prioritize using area for a reaction gas discharge port manifold in a distribution zone; this results in inadequate coolant supply close to the gas discharge port, so a local hot zone will arise in this part compared with a middle region of the plate body. Another possibility is that as the gas reaction proceeds, coolant gradually absorbs heat and increases in temperature in the fuel cell, and consequently, the cooling effect might not be the same upstream and downstream of the plate body, or in the middle and at the edges thereof. In addition, differences in the manufacturing processes of each duct in the coolant flow paths might also cause non-uniform temperature distribution.

In view of the above, it is hoped that an improved fuel cell heat management solution will be provided, to make the temperature distribution of the fuel cell as a whole more balanced.

### SUMMARY

An objective of the present disclosure is to provide a fuel cell component, a fuel cell system, and a heat management method for the fuel cell component, to solve at least some of the problems in the prior art.

According to a first aspect of the present disclosure, a fuel cell component is provided, comprising a plate body, with the following provided on the plate body:
an anode gas flow path leading from an anode inlet to an anode outlet;
a cathode gas flow path leading from a cathode inlet to a cathode outlet; and

a coolant flow path leading from a coolant inlet to a coolant outlet, the coolant flow path being configured such that coolant is partially diverted from the coolant inlet to a designated region of the plate body and mixes with an undiverted portion in the designated region, in order to enhance cooling capacity in the designated region by means of the mixed coolant.

The present disclosure in particular comprises the following technical concept: a region where cooling is inadequate can be replenished with locally excess cooling liquid by a diversion operation, in order to enhance cooling capacity in the selected region. The operation of mixing with an originally guided portion prevents the diverted portion from causing temperature shock locally in the plate body, thereby achieving a gentler cooling boost effect overall. In addition, coolant is diverted to a specified position directly from a single inlet, without the need here to add a coolant inlet for the purpose of introducing additional coolant, which would result in an increased manifold area, so the compact design of the fuel cell is still ensured overall.

Optionally, the plate body is divided into an upstream region close to the cathode inlet and a downstream region close to the cathode outlet, the designated region being positioned in the downstream region; and/or the plate body is divided into an edge region and a middle region, the designated region being positioned in the edge region of the plate body.

In the sense of the present disclosure, an outermost reaction gas flow path is for example positioned in the edge region of the plate body. The middle region is for example at least partially surrounded by the outermost reaction gas flow path.

Here, the following technical advantages are in particular realized: The inputted cathode gas generally produces significant heat after undergoing a reaction, but the cathode gas close to an upstream position has not yet reacted completely, so the plate body temperature is lower in this region. If a portion of cooling liquid that was originally fed to the upstream region is diverted to the downstream region, excess cooling liquid can be supplied for the purpose of neutralizing a greater amount of heat downstream. In addition, the reaction gas inlets and outlets are in most cases arranged at the corners of the plate body, and thus occupy some of the coolant manifold area in these regions; as a result, the cooling effect in the middle of the plate body is in most cases better than in the edge region, so the designated region can advantageously be positioned in the edge region. Thus, more rational distribution of cooling liquid is achieved without additionally increasing the amount of cooling liquid supplied.

Optionally, the coolant flow path is constructed such that a diverted portion is guided to the designated region from a second side and/or a third side adjacent to a first side of the plate body where the coolant inlet is positioned; and/or
the coolant flow path is constructed such that the diverted portion is guided to the designated region close to the edge region of the plate body from the first side of the plate body where the coolant inlet is positioned.

Here, the following technical advantages are in particular realized: When the diversion convergence point is located at a side adjacent to the coolant inlet, the cooling effect in the middle region of the plate body can be influenced directly. When the diversion convergence point is located at an edge on the same side as the coolant inlet, the flow direction of the diverted portion can be kept substantially the same as that of the undiverted portion, in order to focus on enhancing the guiding of coolant in a side region.

Optionally, the coolant flow path is constructed as a corrugated flow path at least in the designated region, such that an overlap region is formed between at least two adjacent secondary flow paths of the coolant flow path, the at least two adjacent secondary flow paths being in communication with each other in the overlap region; and/or the coolant flow path is constructed as a straight-through flow path in a region of the plate body other than the designated region, such that at least two adjacent secondary flow paths of the coolant flow path are isolated from each other.

Here, the following technical advantages are in particular realized: The corrugated flow path enables mixing of coolant between adjacent secondary flow paths, so even if the diverted portion converges from an edge of the plate body, it can still naturally diffuse toward other positions of the plate body as a result of this special structure, thus avoiding local coolant excess or deficiency. The use of the straight-through flow path at the remaining positions can reduce the difficulty of processing of the plate assembly as a whole.

Optionally, if the corrugated flow path is present, a first overlap region is formed between one set of adjacent secondary flow paths in the coolant flow path, and a second overlap region is formed between another set of adjacent secondary flow paths, the first overlap region and the second overlap region being different in area, shape and/or quantity.

The overall course of the diverted portion in the designated region can be influenced in particular through suitable adjustment of the distribution and structure of the overlapping regions, in order to achieve a further optimized cooling effect.

Optionally, the coolant flow path comprises a main flow path and a bypass flow path, and the coolant flow path is constructed such that the diverted portion is guided by means of the bypass flow path before reaching the designated region, and is guided together with the undiverted portion by means of the main flow path after reaching the designated region.

Here, the following technical advantage is in particular realized: the coolant guided in the bypass flow path and the coolant guided in the main flow path are not isolated from each other from beginning to end, but instead merge with each other after reaching the designated region and are guided along a single path, thus preventing the diverted portion from causing a shock-like change in temperature in the designated region. Thus, a gentler cooling boost effect can be achieved overall, thereby encouraging a more uniform distribution of temperature.

Optionally, the plate body is divided into a reaction zone and a non-reaction zone, a cathode gas and an anode gas separately undergo an electrochemical reaction in the reaction zone, and the bypass flow path is arranged in the non-reaction zone.

Here, the following technical advantage is in particular realized: The non-reaction zone is generally not covered by the gas flow field, so allows the diverted coolant to undergo less heat exchange with the surrounding environment before actually acting, in order to stay at a lower temperature.

Optionally, the bypass flow path merges with the main flow path in a direction substantially perpendicular to a guiding direction of the main flow path.

Here, the following technical advantage is in particular realized: A temperature gradient can be calculated along the coolant flow direction, and the diverted portion can be fed in according to different temperature gradients, thereby performing cooling more effectively.

Optionally, the bypass flow path has multiple merging parts with the main flow path, wherein the multiple merging parts can selectively connect the bypass flow path to the main flow path or isolate the bypass flow path from the main flow path according to the position of the designated region in the plate body.

Here, the following technical advantage is in particular realized: For different reasons, hot zones might arise at different positions of the plate body; by adjusting the position of the diversion convergence point, an optimal cooling effect can be achieved in diverse scenarios.

Optionally, the bypass flow path of the coolant flow path is connected to a secondary flow path in the main flow path via a merging part, wherein the secondary flow path has first and second cross-sectional areas upstream and downstream of the merging part respectively, the first cross-sectional area being different from the second cross-sectional area.

Here, the following technical advantage is in particular realized: The diverted portion in most cases accounts for only a small proportion of the total coolant, so when the diverted portion is converged by convection, it might not be guided in accordance with the desired course. Thus, the sizes of the cross-sectional area of the flow path before and after the convergence point can be controlled so that the pressure drop in the fluid duct meets requirements, and in turn so that the diverted portion reaches the desired position as accurately as possible.

Optionally, the coolant outlet is arranged on a fourth side of the plate body where the cathode outlet is positioned, and the coolant inlet is arranged on a first side of the plate body where the cathode inlet is positioned.

Here, the following technical advantage is in particular realized: When a reaction gas inlet/outlet is arranged side by side with the coolant inlet, a double manifold region can share the length of the plate body on the same side, thereby saving the area of a manifold added in an orthogonal direction, and achieving a more compact fuel cell arrangement.

According to a second aspect of the present disclosure, a fuel cell system is provided, comprising the fuel cell component according to the first aspect of the present disclosure, in particular a bipolar plate.

According to a third aspect of the present disclosure, a heat management method for a fuel cell component is provided, the method being configured to be implemented by means of the fuel cell component according to the first aspect of the present disclosure, and the method comprising the following steps:
diverting coolant, and partially guiding a diverted portion from a coolant inlet to a designated region of a plate body;
mixing the diverted portion and an undiverted portion in the designated region; and
enhancing cooling capacity in the designated region by means of the mixed coolant.

### BRIEF DESCRIPTION OF THE DRAWINGS

The present disclosure is described in greater detail below with reference to the drawings, to enable a better understanding of the principles, characteristics and advantages of the present disclosure. Here, identical or functionally identical elements have the same reference labels. The drawings are in particular intended to illustrate principles that are important to the present disclosure, and are not necessarily drawn to scale. For the sake of clarity, it can be stipulated that not all reference labels are drawn in all of the drawings. The drawings include:

FIG. 1 shows a planar drawing of a fuel cell component according to an exemplary embodiment of the present disclosure.

FIG. 2 shows a planar drawing of a fuel cell component according to another exemplary embodiment of the present disclosure.

FIG. 3 shows a planar drawing of a fuel cell component according to another exemplary embodiment of the present disclosure.

FIG. 4 shows a schematic drawing of a flow path structure of a fuel cell component according to an exemplary embodiment of the present disclosure.

FIG. 5 shows a schematic drawing of a flow path structure of a fuel cell component according to another exemplary embodiment of the present disclosure.

FIG. 6 shows a sectional drawing of part of a fuel cell component according to an exemplary embodiment of the present disclosure.

FIG. 7 shows a sectional drawing of part of a fuel cell component according to an exemplary embodiment of the present disclosure; and

FIG. 8 shows a flow chart of a heat management method for a fuel cell component according to an exemplary embodiment of the present disclosure.

### DETAILED DESCRIPTION

To clarify the technical problem to be solved by the present disclosure, as well as the technical solution and beneficial technical effects thereof, the present disclosure is explained in further detail below with reference to the drawings and multiple exemplary embodiments. It should be understood that the particular embodiments described here are merely intended to explain the present disclosure, not to limit the scope of protection thereof.

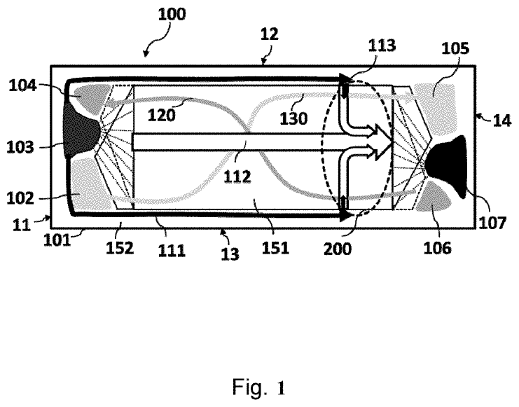

FIG. 1 shows a planar drawing of a fuel cell component according to an exemplary embodiment of the present disclosure.

As an example, the fuel cell component 100 according to the present disclosure may be a bipolar plate for a proton exchange membrane fuel cell, and for example comprises a plate body 101, on which plate body 101 are provided an anode inlet 106, an anode outlet 104, a cathode inlet 102, a cathode outlet 105, a coolant inlet 103 and a coolant outlet 107, wherein the cathode inlet 102, coolant inlet 103 and anode outlet 104 are positioned on a first side 11 of the plate body 101, and the cathode outlet 105, coolant outlet 107 and anode inlet 106 are positioned on a fourth side 14 of the plate body 101 opposite the first side 11. Thus, a triple manifold region can share the length of the plate body on the same side, thereby saving the area of a manifold added in an orthogonal direction (i.e. on a second side 12 and a third side 13).

Also shown demonstratively are an anode gas flow path 120 extending from the anode inlet 106 to the anode outlet 104, a cathode gas flow path 130 extending from the cathode inlet 102 to the cathode outlet 105, and a coolant flow path 111, 112 extending from the coolant inlet 103 to the coolant outlet 107. Here, it should be noted that the flow paths shown are merely intended to illustrate the overall course of reaction gases and coolant in a plate body flow field region, not to define the specific structure, number and arrangement of flow paths. In this example, the direction in which the cathode gas (e.g. air) is guided is the same as the direction in which coolant is guided and opposite to the direction in which the anode gas (e.g. hydrogen) is guided; this is called counter-flow, but the use of a co-flow arrangement can also be envisaged.

Here, a coolant flow path is configured such that coolant is partially diverted from the coolant inlet 103 to a designated region 200 of the plate body 101 and mixes with an undiverted portion in the designated region 200, in order to enhance the cooling capacity in the designated region 200 by means of the mixed coolant. Demonstratively, the diverted portion is guided to the designated region 200 from the second side 12 and third side 13, which are adjacent to the first side 11 of the plate body 101 where the coolant inlet 103 is positioned. To achieve such diversion, the coolant flow path may comprise a main flow path 112 and a bypass flow path 111, with the main flow path 112 for example being located in a reaction zone 151 of the plate body 101, and the bypass flow path 111 being located in a non-reaction zone 152. In the sense of the present disclosure, the reaction zone 151 is also called the flow field zone, and corresponds to an active zone of a proton exchange membrane (MEA) of the fuel cell, being an important region for the gas reaction to take place. In this region, the anode gas and cathode gas separately enter the MEA and take part in an electrochemical reaction. The non-reaction zone 152 may comprise a common duct zone, a distributing zone, etc.; as a transitional region, the non-reaction zone 152 causes the reaction gases to be distributed uniformly in each flow path when they are guided to flow from the gas sources 102, 106 to the reaction zone 151, while also making the flow rates of coolant entering each coolant manifold uniform. Thus, a portion of coolant from the coolant inlet 103 is diverted, and guided by means of the bypass flow path 111 in the non-reaction zone 152; in the designated region 200 located downstream of the reaction zone 151 of the plate body 101, the bypass flow path 111 merges with the main flow path 112 in a direction substantially perpendicular to the main flow path 112 (and thus also perpendicular to the overall course of the reaction gases) via merging parts 113 on the second side 12 and third side 13 of the plate body 101. Thus, the diverted liquid and the undiverted portion that was originally guided by means of the main flow path 112 mix in the designated region 200 and are guided together by means of the main flow path 112, in order to enhance the cooling capacity in the designated region 200.

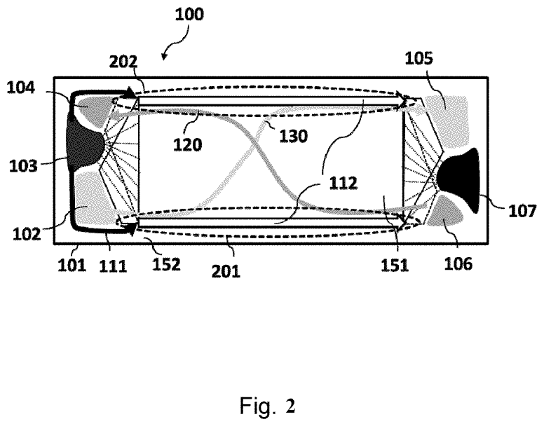

FIG. 2 shows a planar drawing of a fuel cell component according to another exemplary embodiment of the present disclosure.

FIG. 2 differs from FIG. 1 in that: designated regions 201, 202 are no longer positioned in a downstream region of the plate body 101, instead being positioned in edge regions of the plate body 101. In this case, the bypass flow path 111 of the coolant flow path leads to the designated regions 201, 202 close to the plate body edge regions from the first side 11 of the plate body 101 where the coolant inlet 103 is positioned. Because such a bypass path going around the cathode inlet 102 and the anode outlet 104 is formed in a transitional zone of the plate body, the coolant thereby fed into the reaction zone 151 is guided in a direction which is essentially fixed, and so cannot be freely distributed into multiple channels by means of manifolds, as happens with other coolant passing through the transitional zone. Therefore, the coolant flow direction in the reaction zone 151 also remains substantially the same as a feed-in direction, thereby always remaining parallel to the flow direction of reaction gas to reach the outlet end. Thus, enhancement of cooling capacity is focussed at side parts of the plate body 101.

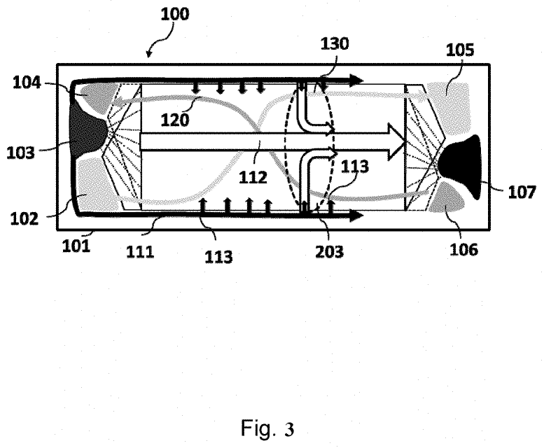

FIG. 3 shows a planar drawing of a fuel cell component according to another exemplary embodiment of the present disclosure.

FIG. 3 differs from FIG. 1 in that: a designated region 203 in FIG. 3 is moved in an upstream direction of the plate body 101, compared with the designated region 203 in FIG. 1. In this example, the bypass flow path 111 has multiple merging parts 113 with the main flow path 112; these merging parts 113 can selectively connect the bypass flow path 111 to the main flow path 112 or isolate the bypass flow path 111 from the main flow path 112 according to the position of the designated region 203 in the plate body 101. For example, corresponding valves are for example integrated in each of the merging parts 113, to be used for controlling the flow speed and flow rate of the diverted portion. As an example, if it is desired to enhance the cooling capacity at an edge of the plate body 101, then it is possible to only open a downstream merging part 113, so that less of the diverted portion converges to the middle before reaching the source of heat. If it is desired that the fluid fed in by the bypass mixes as fully as possible with the undiverted portion before flowing toward the middle of the plate body, then the point of convergence can be moved as far as possible in the upstream direction, so that the diverted coolant traverses as long a guiding path as possible before reaching the source of heat in the middle of the plate body 101.

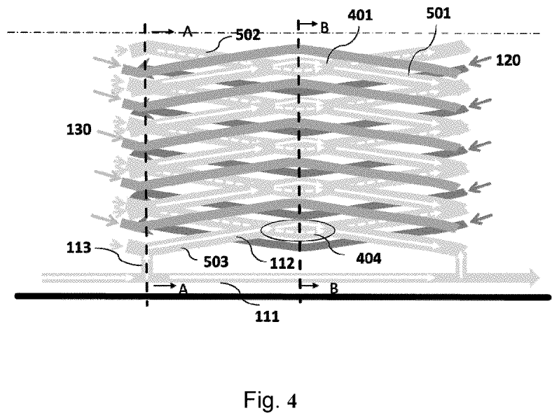

FIG. 4 shows a schematic drawing of a flow path structure of a fuel cell component according to an exemplary embodiment of the present disclosure.

The anode gas flow path 120, the cathode gas flow path 130, and the main flow path 112 and bypass flow path 111 for coolant in the designated region are shown here. In this example, the main flow path 112 for coolant and the reaction gas flow paths 120, 130 are positioned adjacent to each other, so that the heat generated by the reaction is fully absorbed in the reaction zone of the plate body 101.

As can be seen, the main flow path 112 of the coolant flow path is constructed in such a way as to be corrugated in the designated region, such that an overlap region 401 is formed between two adjacent secondary flow paths 501, 502, in which overlap region 401 the two secondary flow paths 501, 502 are in communication with each other; consequently, different portions of coolant in the main flow path 112 are in communication with each other overall. The bypass flow path 111 leads along the edge of the plate body, remaining isolated from the main flow path 111 at all times, and as can be seen, does not intersect or overlap with the reaction gas flow paths 120, 130; consequently, it can be ensured that in the process of being guided, the diverted portion undergoes less heat exchange with the surrounding environment. At the merging part 113, the bypass flow path 111 merges with the main flow path 112, thus the diverted coolant converges into an outermost secondary flow path 503 of the main flow path 112 from the bypass flow path 111; there, the coolant is first guided along the outermost secondary flow path 503 for a certain distance, and upon reaching a region 404 of overlap with the adjacent secondary flow path, this portion of coolant intersects and merges with other coolant in the overlap region 404. This progressively overlapping flow path structure enables the diverted portion to fully diffuse naturally in the designated region, thereby achieving a cooling effect that is more uniform overall. However, depending on the position at which the hot zone appears in the plate body, it is also possible to suitably change the structure of the outermost secondary flow path 503, such that the secondary flow path 503 has first and second cross-sectional areas upstream and downstream of the merging part 113 respectively, the first cross-sectional area being different from the second cross-sectional area (not specifically shown for the sake of clarity). As an example, when it is desired to mainly cool an edge region of the plate body, the sectional area of the outside secondary flow path 503 can be gradually reduced after passing the merging part 113, such that the diverted portion, after converging, is guided toward the two ends of the plate body in a concentrated fashion due to the pressure drop formed. If it is desired that more of the diverted portion reaches the middle region of the plate body, the number or area of overlap regions 404 can be increased.

Although a corrugated flow path structure is mainly shown in FIG. 4, the coolant flow path and corresponding gas flow paths may be constructed as straight-through flow paths in regions other than the designated region, so that the cost of processing can be reduced as much as possible.

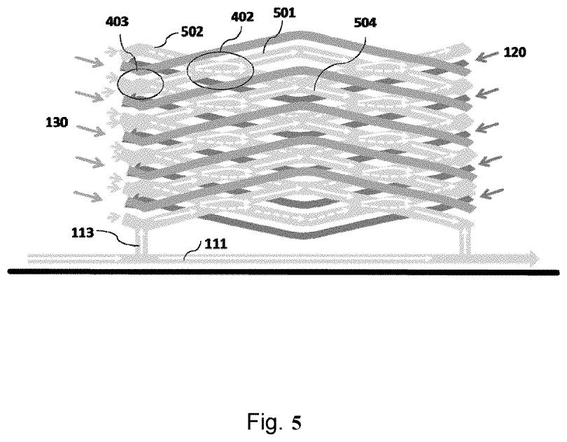

FIG. 5 shows a schematic drawing of a flow path structure of a fuel cell component according to another exemplary embodiment of the present disclosure.

FIG. 5 differs from FIG. 4 in that: in the region shown in FIG. 5, identical overlap regions are no longer formed between any two adjacent secondary flow paths; the overlap regions that are formed might be different in area, shape and/or quantity. As shown in FIG. 5, a first overlap region 402 is formed between one set of adjacent secondary flow paths 501, 502, and a second overlap region 403 is formed between another set of adjacent secondary flow paths 501, 504. As can be seen, the first overlap region 402 is elliptical overall and has a larger area, while the second overlap region 403 has a smaller area. Such non-uniform distribution of overlap regions can be adjusted in particular according to the position of the region where it is desired to enhance cooling capacity, in order to controllably influence the course of the diverted portion after reaching the designated region.

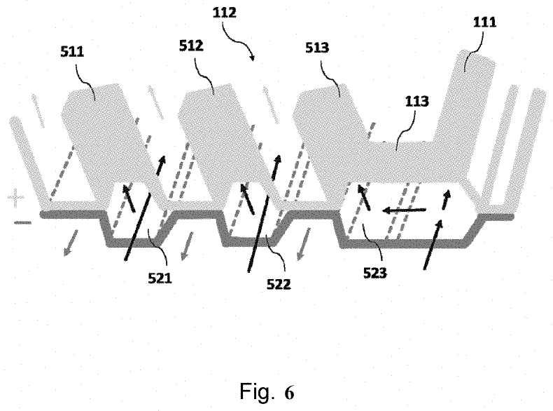

FIG. 6 shows a sectional drawing of part of a fuel cell component according to an exemplary embodiment of the present disclosure. A sectional view along the cutting plane A-A in FIG. 4 is shown here; at this cutting plane, the coolant bypass flow path 111 is connected via the merging part 113 to an outermost secondary flow path 513 in the coolant main flow path 112. The plate body 101 may for example comprise an upper plate body and a lower plate body; cathode gas located at an upper side of the plate body 101 and anode gas located at a lower side of the plate body 101 are isolated from each other by the plate body 101. The coolant flow path is formed between the upper and lower plate bodies of the plate body 101. Coolant secondary flow paths 511, 512, 513 extending in a first direction and coolant secondary flow paths 521, 522, 523 extending in a second direction in the segment shown can be seen here; the secondary flow paths in these two directions have regions of overlap with each other at the cutting plane shown, thereby allowing convective merging of coolant guided in different directions.

Due to this special flow path structure, when feeding the diverted portion into the designated region, the bypass flow path 111 need only supply coolant to the outermost secondary flow path 513 via the merging part 113, without the need to continue extending toward the middle of the plate body by means of the bypass flow path; this is because the coolant that converges into the secondary flow path 513 can mix into another, adjacent secondary flow path 523 by means of the overlap region, and in the next cycle can naturally diffuse further toward the middle of the plate body (i.e. the left side in the figure), in order to achieve uniform cooling enhancement throughout the designated region.

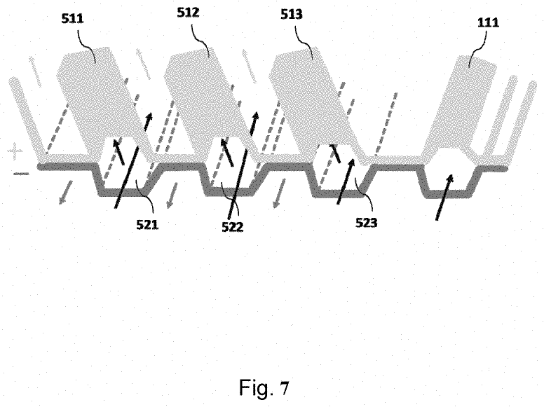

FIG. 7 shows a sectional drawing of part of a fuel cell component according to an exemplary embodiment of the present disclosure. A sectional view along the cutting plane B-B in FIG. 4 is shown here; at this cutting plane, there is no merging part between the coolant bypass flow path 111 and the main flow path 112, so they lead independently of each other. In particular, it can be seen that there is no guiding of reactants around the bypass flow path 111, so direct adjacency of the diverted portion to the reaction gases during guiding can be prevented, in order to absorb less heat from the surrounding environment.

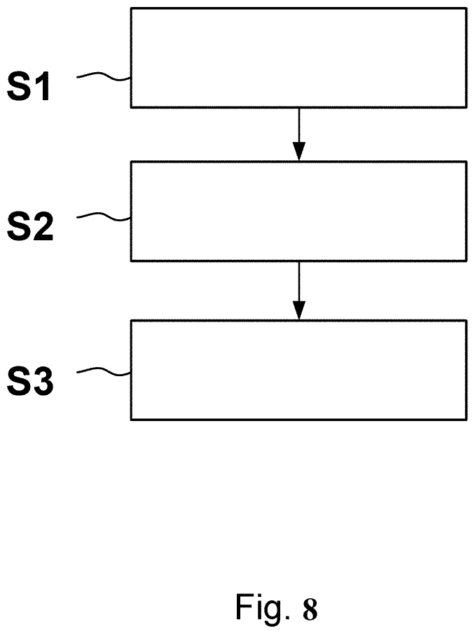

FIG. 8 shows a flow chart of a heat management method for a fuel cell component according to an exemplary embodiment of the present disclosure. The method is performed for example by means of the fuel cell components shown in FIGS. 1-3. In step S1, coolant is diverted by means of a coolant bypass flow path, and the diverted portion is partially guided from a coolant inlet to a designated region of a plate body. In step S2, the diverted portion and an undiverted portion are mixed in the designated region. This may for example be achieved by means of a merging part between the bypass flow path and the main flow path. Then in step S3, cooling capacity in the designated region is enhanced by means of the mixed coolant.

In this specification, “substantially perpendicular to” in particular specifies the orientation of one direction relative to a reference direction, wherein said direction and the reference direction enclose an angle of 90° especially when viewed in a plane, the angle having a maximum error of especially less than 8°, advantageously less than 5° and especially advantageously less than 2°. Although specific embodiments of the present disclosure have been described in detail here, they are provided merely for the purpose of explanation, and should not be regarded as limiting the scope of the present disclosure. Various substitutions, changes and modifications can be envisaged without departing from the spirit and scope of the present disclosure.

What is claimed is:

1. A fuel cell component, comprising:
a plate body including
an anode gas flow path leading from an anode inlet to an anode outlet;
a cathode gas flow path leading from a cathode inlet to a cathode outlet; and
a coolant flow path leading from a coolant inlet to a coolant outlet, the coolant flow path configured such that coolant is partially diverted from the coolant inlet to a designated region of the plate body and mixes with an undiverted portion in the designated region, such that cooling capacity is enhanced in the designated region by the mixed coolant.

2. The fuel cell component according to claim 1, wherein:
the plate body is divided into an upstream region close to the cathode inlet and a downstream region close to the cathode outlet, and the designated region is positioned in the downstream region; and/or
the plate body is divided into an edge region and a middle region, and the designated region is positioned in the edge region of the plate body.

3. The fuel cell component according to claim 1, wherein:
the coolant flow path is constructed such that a diverted portion is guided to the designated region from a second side and/or a third side adjacent to a first side of the plate body where the coolant inlet is positioned; and/or
the coolant flow path is constructed such that the diverted portion is guided to the designated region close to the edge region of the plate body from the first side of the plate body where the coolant inlet is positioned.

4. The fuel cell component according to claim 1, wherein:
the coolant flow path is constructed as a corrugated flow path at least in the designated region, such that an overlap region is formed between at least two adjacent secondary flow paths of the coolant flow path, the at least two adjacent secondary flow paths in communication with each other in the overlap region; and/or
the coolant flow path is constructed as a straight-through flow path in a region of the plate body other than the designated region, such that at least two adjacent secondary flow paths of the coolant flow path are isolated from each other.

5. The fuel cell component according to claim 4, wherein, when the corrugated flow path is present, a first overlap region is formed between one set of adjacent secondary flow paths in the coolant flow path, and a second overlap region is formed between another set of adjacent secondary flow paths, the first overlap region different in area, shape and/or quantity from the second overlap region.

6. The fuel cell component according to any one of claim 1, wherein:
the coolant flow path comprises a main flow path and a bypass flow path; and
the coolant flow path is constructed such that the diverted portion is guided by the bypass flow path before reaching the designated region, and is guided together with the undiverted portion by the main flow path after reaching the designated region.

7. The fuel cell component according to claim 6, wherein:
the plate body is divided into a reaction zone and a non-reaction zone;
a cathode gas and an anode gas separately undergo an electrochemical reaction in the reaction zone; and
the bypass flow path is arranged in the non-reaction zone.

8. The fuel cell component according to claim 6, wherein the bypass flow path merges with the main flow path in a direction substantially perpendicular to a guiding direction of the main flow path.

9. The fuel cell component according to claim 6, wherein;
the bypass flow path has multiple merging parts with the main flow path; and
the multiple merging parts selectively connect the bypass flow path to the main flow path or isolate the bypass flow path from the main flow path according to the position of the designated region in the plate body.

10. The fuel cell component according to claim 6, wherein:
the bypass flow path of the coolant flow path is connected to a secondary flow path in the main flow via a merging part; and
the secondary flow path has first and second cross-sectional areas upstream and downstream of the merging part respectively, the first cross-sectional area different from the second cross-sectional area.

11. The fuel cell component according to claim 1, wherein:
the coolant outlet is arranged on a fourth side of the plate body where the cathode outlet is positioned; and
the coolant inlet is arranged on a first side of the plate body where the cathode inlet is positioned.

12. A fuel cell system, comprising:
the fuel cell component according to claim 1, wherein the fuel cell component is a bipolar plate.

13. A heat management method for a fuel cell component, comprising:
providing a fuel cell component with a plate body including
an anode gas flow path leading from an anode inlet to an anode outlet;
a cathode gas flow path leading from a cathode inlet to a cathode outlet; and
a coolant flow path leading from a coolant inlet to a coolant outlet, the coolant flow path configured such that coolant is partially diverted from the coolant inlet to a designated region of the plate body and mixes with an undiverted portion in the designated region, such that cooling capacity is enhanced in the designated region by the mixed coolant;
diverting coolant, and partially guiding a diverted portion from the coolant inlet to the designated region of the plate body;
mixing the diverted portion and an undiverted portion in the designated region; and
enhancing cooling capacity in the designated region using the mixed coolant.
